(19) United States
(12) Patent Application Publication
(10) Pub. No.: US 2012/0240731 A1
(43) Pub. Date: Sep. 27, 2012

(54) Tool extension

(76) Inventor: Te Chen Chu, Taichung (TW)

(21) Appl. No.: 13/065,440

(22) Filed: Mar. 22, 2011

(51) Int. Cl. B25B 23/00

(52) U.S. Cl. 81/57.5

(57) ABSTRACT

A tool extension includes a receiving member having a stem and a casing, the stem includes an engaging hole for engaging with a driving tool, and the casing includes an space formed between two plates for engaging with an adapter, the adapter includes a number of radially extended protrusions for rotating and directing toward and away from the stem, the adapter and includes a socket opening formed in each of the protrusions for engaging with various tool elements or fasteners. The casing includes a spring biased projection engaged in one of the plates for selectively engaging with the adapter and for positioning the adapter to the casing.

### BACKGROUND OF THE INVENTION

1. Field of the Invention

The present invention relates to a universal joint or tool extension, and more particularly to a universal joint or tool extension including a number of different couplers or engaging members for engaging with different tool members or tool elements and for easily and readily driving or rotating various different tool members or tool elements or fasteners.

2. Description of the Prior Art

Typical universal joints or tool extensions comprise two or more parts or elements or sections or couplings pivotally or rotatably connected or coupled together for connecting or coupling various kinds of different tool elements or fasteners to various kinds of different driving tools.

For example, U.S. Pat. No. 4,936,701 to Allen et al., U.S. Pat. No. 4,941,862 to Hazebrook et al., U.S. Pat. No. 5,660,491 to Roberts et al., and U.S. Pat. No. 6,119,559 to Zerver disclose several of the typical universal joints or tool extensions each also comprising two or more pivotally coupled parts or elements or sections or couplings for connecting or coupling various kinds of different driving tools to drive or rotate various kinds of different tool elements or fasteners.

However, normally, the pivotally coupled parts or elements or sections or couplings each may only be used to engage with and to drive a single driven tool element or fastener, but may not be used to engage with and to drive the other different tool elements or fasteners, such that the users have to prepare and to carry two or more different universal joints or tool extensions for engaging with or for connecting or coupling various kinds of different tool members or tool elements or fasteners to various kinds of different driving tools.

The present invention has arisen to mitigate and/or obviate the afore-described disadvantages of the conventional universal joints or tool extensions.

### SUMMARY OF THE INVENTION

The primary objective of the present invention is to provide a universal joint or tool extension including a number of different couplers or engaging members for engaging with different tool members or tool elements and for easily and readily driving or rotating various different tool members or tool elements or fasteners.

In accordance with one aspect of the invention, there is provided a tool extension comprising a receiving member including a stem at one end portion thereof, and a casing at another end portion thereof, the stem including an engaging hole formed therein, and the casing including two plates and an space formed between the plates, and an adapter engaged in the space of the casing and disposed between the plates and pivotally coupled to the plates with a shaft, the adapter including a number of protrusions extended outwardly therefrom for selectively rotating and directing toward and away from the stem, and including a socket opening formed in each of the protrusions.

The casing includes a spring biased projection engaged in one of the plates for selectively engaging with the adapter. The adapter includes a number of depressions formed therein for engaging with the spring biased projection of the casing.

The socket openings of the protrusions include inner diameters different from each other. The receiving member includes at least one flat surface formed in an outer peripheral portion of the stem. The receiving member includes an engaging opening formed therein and communicative with the engaging hole of the stem.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a universal joint or tool extension in accordance with the present invention;

FIG. 2 is an exploded view of the universal joint or tool extension;

FIG. 3 is a cross sectional view of the tool extension taken along lines 3-3 of FIG. 1;

FIG. 4 is a cross sectional view of the tool extension taken along lines 4-4 of FIG. 3;

FIGS. 5, 6, 7, 8, 9 are perspective views illustrating the other arrangement of the universal joint or tool extension;

FIGS. 10, 11, 12, 13, 14, 15 are partial exploded views illustrating the operation of the universal joint or tool extension; and

FIG. 16 is a perspective view illustrating the operation of the universal joint or tool extension.

### DETAILED DESCRIPTION OF THE PREFERRED EMBODIMENT

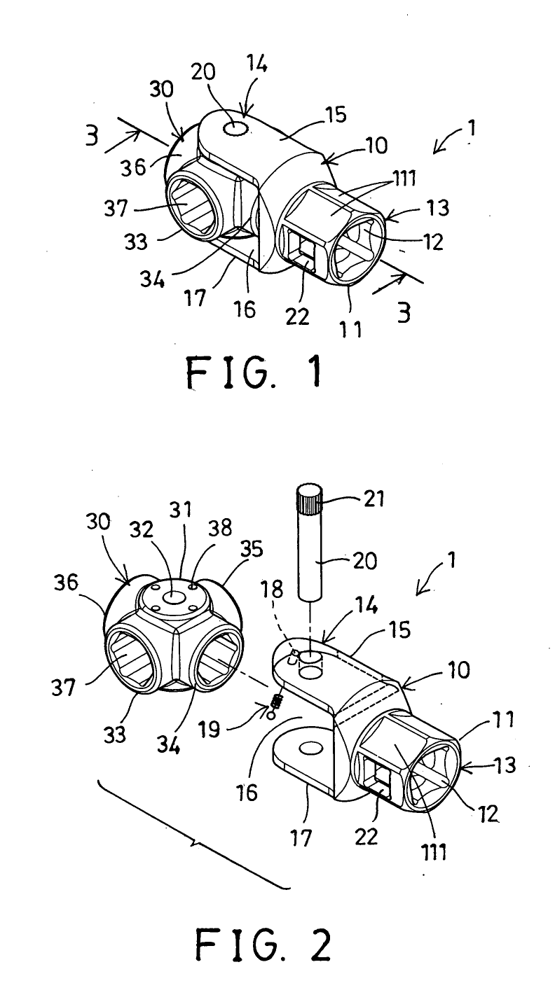

Referring to the drawings, and initially to FIGS. 1-4, a universal joint or tool extension 1 in accordance with the present invention comprises a receiving member 10 including a stem 11 formed or provided on one end portion 13 thereof and having an engaging hole 12 formed in the stem 11 for receiving or engaging with various kinds of different driving tools which will be discussed or described hereinafter. The receiving member 10 further includes a housing or bracket or frame or casing 15 formed or provided on the other end portion 14 thereof and having a chamber or compartment or space 16 formed or defined between two opposite walls or plates 17.

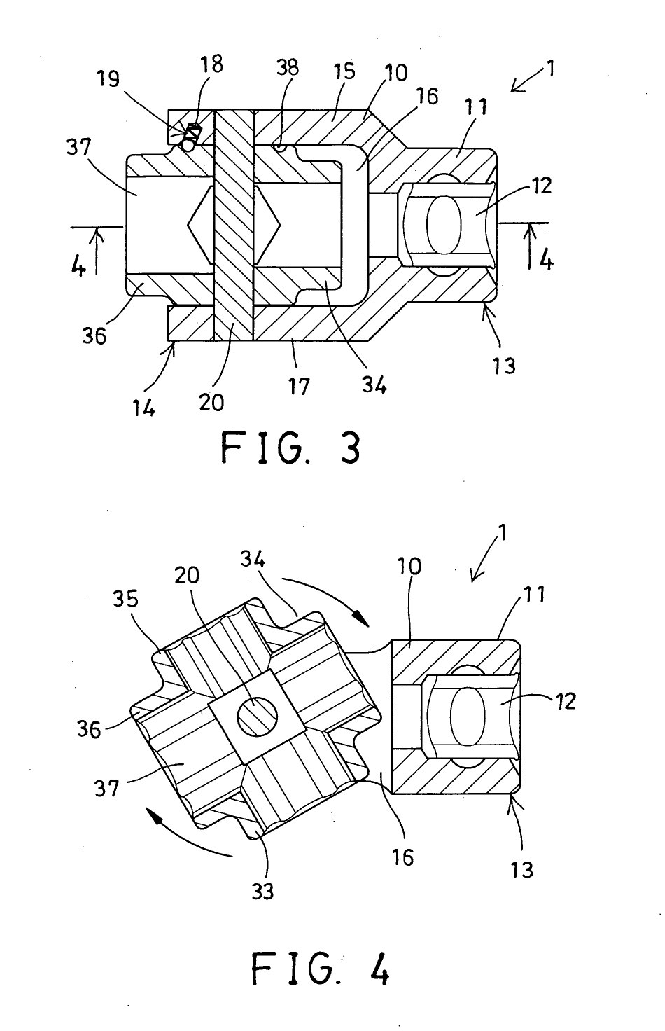

The receiving member 10 further includes a spindle or shaft 20 extended or engaged through the plates 17 or straddled between the plates 17 and extended into or through the space 16 of the casing 15, and preferably perpendicular to the plates 17 and the stem 11. It is preferable that the shaft 20 includes a serrated end portion 21 for frictionally engaging with the casing 15 and for solidly and stably attaching or mounting or anchoring or securing or retaining the shaft 20 to the casing 15. The casing 15 includes a cavity 18 formed therein for receiving or engaging with a spring biased projection 19 which is partially extended into the space 16 of the casing 15 (FIG. 3).

The tool extension 1 further includes a coupler or engaging member or adapter 30 disposed or engaged in the space 16 of the casing 15 and having two side portions 31, such as two flat side portions 31 disposed between and contacted or engaged with the plates 17, and includes an orifice 32 laterally formed through the adapter 30 and formed or extended between the side portions 31 of the adapter 30 for pivotally or rotatably receiving or engaging with the shaft 20 and for pivotally or rotatably attaching or mounting or securing or coupling the adapter 30 to the casing 15 of the receiving member 10 and for allowing the adapter 30 to be pivoted or rotated relative to the receiving member 10.

The adapter 30 includes one or more (such as four) limbs or extensions or legs or protrusions 33, 34, 35, 36 extended outwardly therefrom, such as extended radially and outwardly therefrom and extended or directly radially and outwardly from the center portion thereof for allowing either of the protrusions 33, 34, 35, 36 to be selectively rotated or directed toward or away from the stem 11 of the receiving member 10. The adapter 30 includes a socket opening 37 formed in each of the protrusions 33-36, and the socket openings 37 in the protrusions 33-36 preferably include different sizes or dimensions or inner diameters or configurations for receiving or engaging with various tool members or tool elements or fasteners (not shown) of different sizes or dimensions or inner diameters or configurations.

As shown in FIGS. 2 and 3, the adapter 30 includes one or more (such as four) recesses or depressions 38 formed therein, such as formed in one of the side portions 31 thereof for selectively engaging with the spring biased projection 19 of the casing 15 of the receiving member 10 and for directing or anchoring or securing or retaining or positioning the protrusions 33-36 of the adapter 30 to the receiving member 10 at the required or selected or predetermined direction, and thus for allowing the protrusions 33-36 of the adapter 30 to suitably or easily and quickly and readily engage with the tool members or tool elements or fasteners of the required or selected or predetermined sizes or dimensions or inner diameters or configurations.

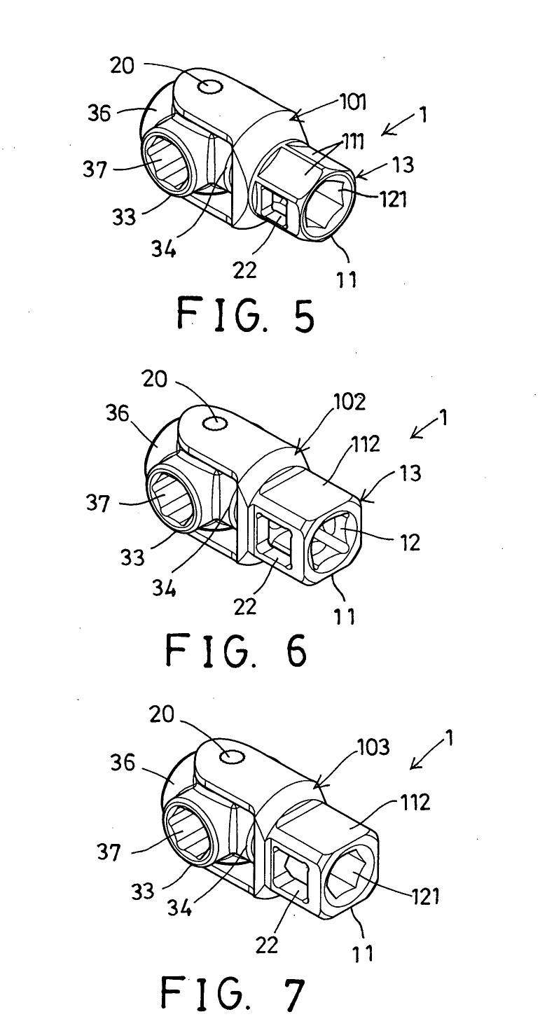

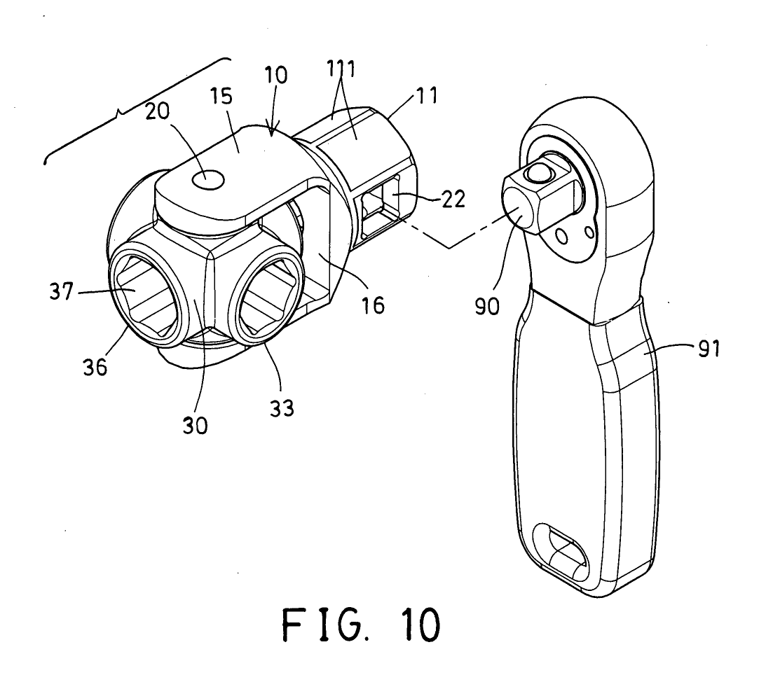

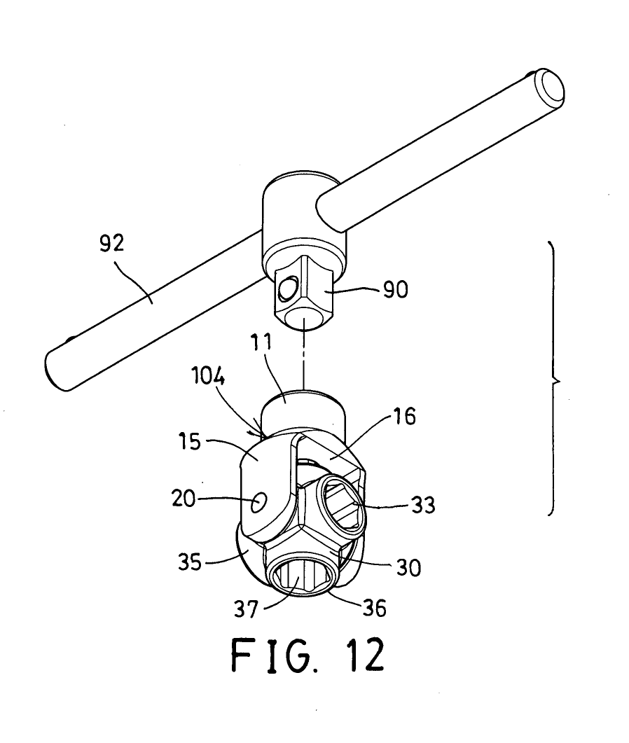

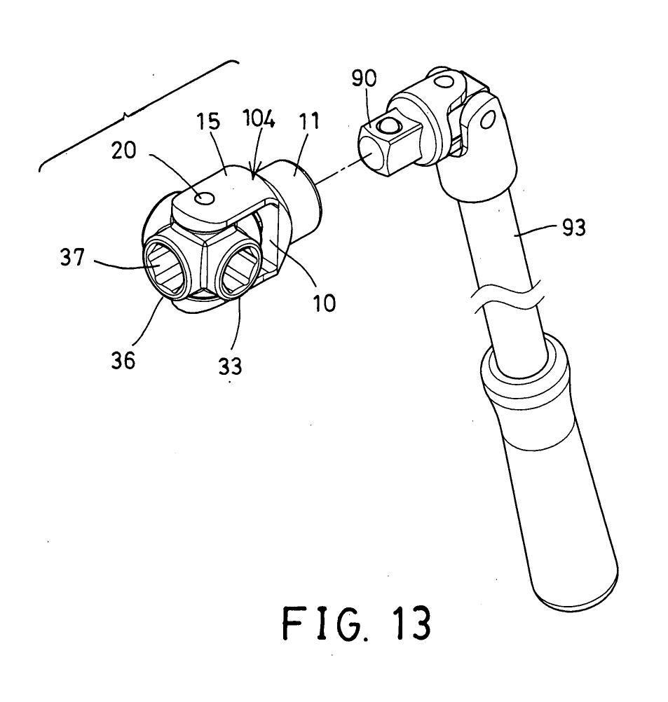

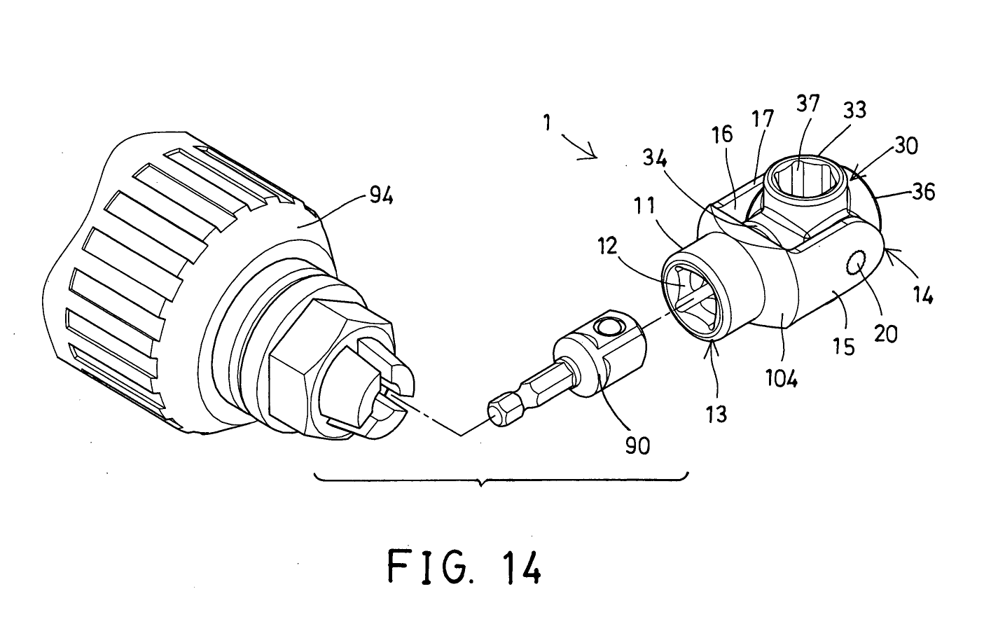

As shown in FIGS. 1-9, the stem 11 of the receiving members 10, 101, 102, 103, 104, 105 may include different sizes or dimensions or inner diameters or configurations for engaging with various driving tools. For example, the engaging hole 12 formed in the stem 11 may include a square cross section (FIGS. 1-4, 6, 8) for selectively engaging with the driving shanks 90 of various driving tools 91-94, such as the ratchet wrench 91 (FIG. 10), the T-shaped tool 92 (FIG. 12), the pivotal tool 93 (FIG. 13), or the automatic driving tool 94 (FIG. 14); or may include an engaging hole 121 of a hexagonal cross section (FIGS. 5, 7, 9) for selectively engaging with the other driving tools (not shown).

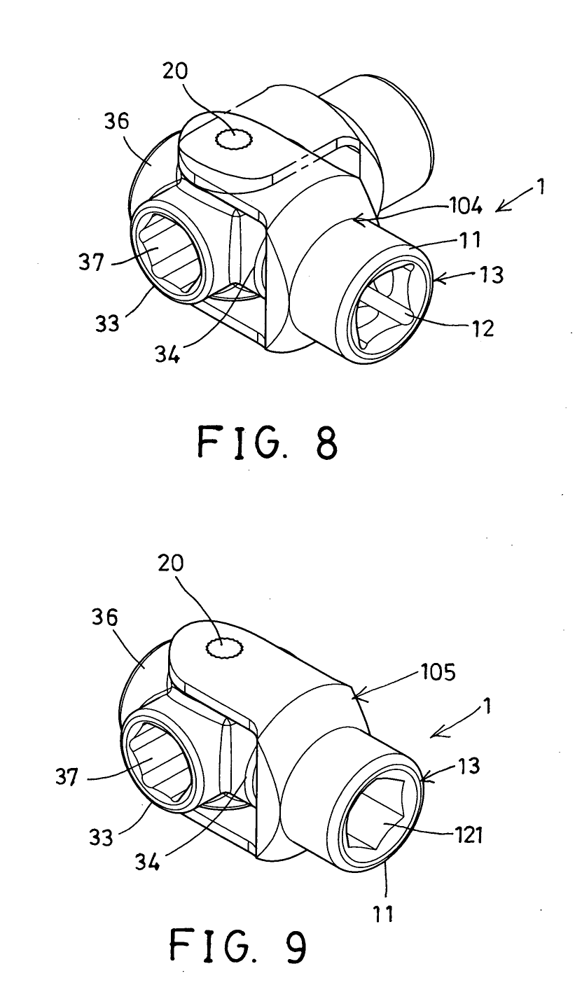

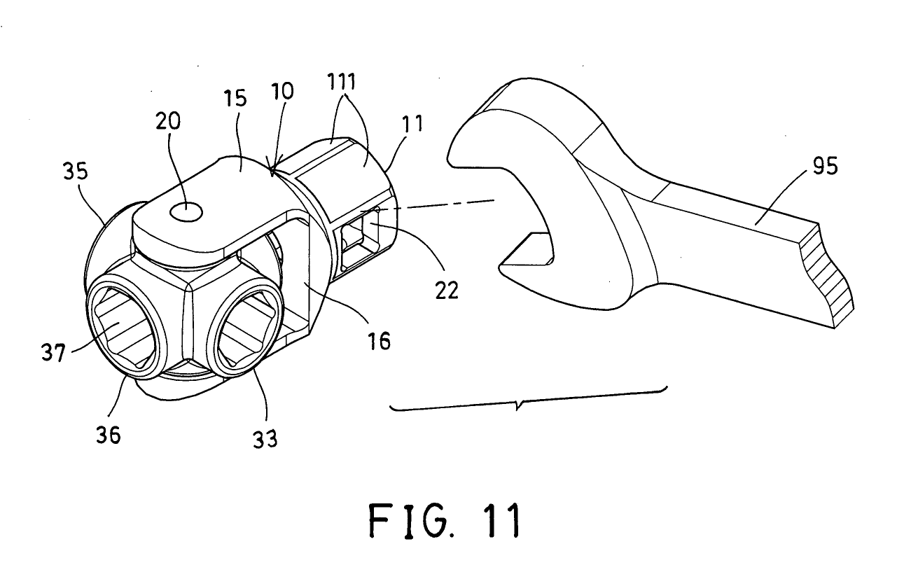

The stem 11 may further include one or more (such as six) flat surfaces 111 formed in the outer peripheral portion thereof (FIGS. 1, 5, 10, 11) for selectively engaging with the driving tools, such as the driving wrench 95 as shown in FIG. 11; or may include four flat surfaces 112 as shown in FIGS. 6 and 7 for selectively engaging with the other driving tools (not shown); or may include a cylindrical shape having no flat surfaces formed in the outer peripheral portion thereof (FIGS. 8-9, 12-16); or may include an engaging opening 22 formed in the lateral or outer peripheral portion thereof and communicative with the engaging hole 12, 121 of the stem 11 for selectively engaging with the driving shank 90 of the driving tool 91, such as the ratchet wrench 91 (FIG. 10).

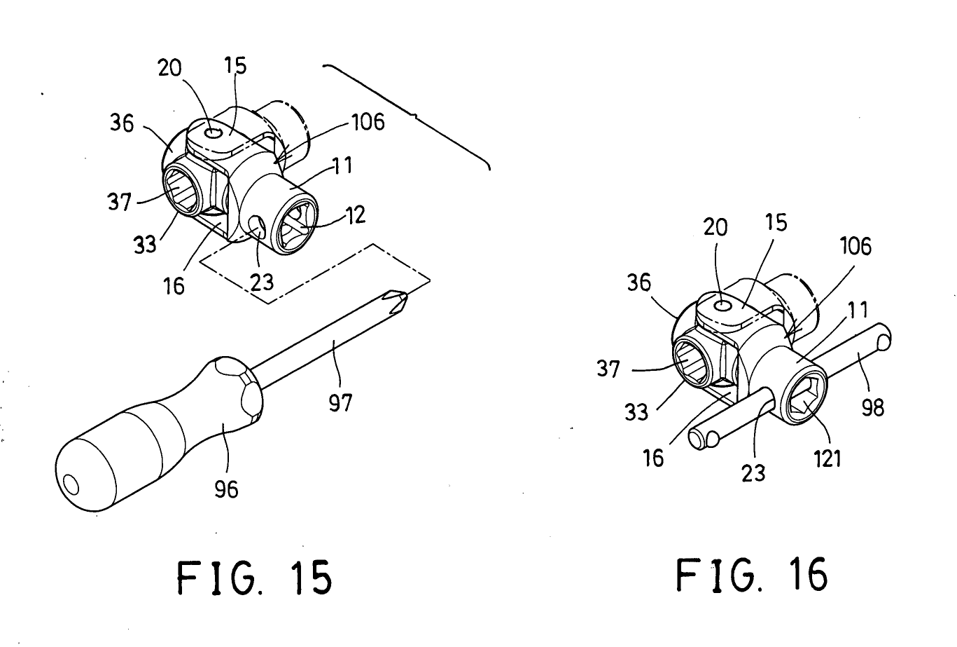

As shown in FIGS. 15-16, the stem 11 of the receiving member 106 may include a through hole 23 laterally formed through the stem 11 and communicative with the engaging hole 12, 121 of the stem 11 for receiving or engaging with the driving rod 97 of the driving tool 96, such as the screw driver 96 (FIG. 15), or for receiving or engaging with the other driving rods 98 (FIG. 16), such that the stem 11 of the receiving members 10, 101, 102, 103, 104, 105, 106 may be selectively rotated or driven by various kinds of different driving tools.

Accordingly, the universal joint or tool extension in accordance with the present invention includes a number of different couplers or engaging members for engaging with different tool members or tool elements and for easily and readily driving or rotating various different tool members or tool elements or fasteners.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A tool extension comprising:
a receiving member including a stem at one end portion thereof, and a casing at another end portion thereof, said stem including an engaging hole formed therein, and said casing including two plates and an space formed between said plates, and
an adapter engaged in said space of said casing and disposed between said plates and pivotally coupled to said plates with a shaft, said adapter including a plurality of protrusions extended outwardly therefrom for selectively rotating and directing toward and away from said stem, and including a socket opening formed in each of said protrusions.

2. The tool extension as claimed in claim 1, wherein said socket openings of said protrusions include inner diameters different from each other.

3. The tool extension as claimed in claim 1, wherein said casing includes a spring biased projection engaged in one of said plates for selectively engaging with said adapter.

4. The tool extension as claimed in claim 3, wherein said adapter includes a plurality of depressions formed therein for engaging with said spring biased projection of said casing.

5. The tool extension as claimed in claim 1, wherein said receiving member includes at least one flat surface formed in an outer peripheral portion of said stem.

6. The tool extension as claimed in claim 1, wherein said receiving member includes an engaging opening formed therein and communicative with said engaging hole of said stem.
